(19) United States
(12) Patent Application Publication
(10) Pub. No.: US 2011/0135097 A1
(43) Pub. Date: Jun. 9, 2011

(54) Updating Encryption Keys in a Radio Communication System

(75) Inventors: Andrew David Redfern, Christchurch (NZ); Guy Alexander Hooker, Christchurch (NZ); Hamish Andrew Smith, Lyttelton (NZ); Lionel James Hopgood, Christchurch (NZ)

(73) Assignee: TAIT ELECTRONICS LIMITED, Christchurch (NZ)

(21) Appl. No.: 12/904,268

(22) Filed: Oct. 14, 2010

Related U.S. Application Data
(60) Provisional application No. 61/251,372, filed on Oct. 14, 2009.

(51) Int. Cl. H04L 9/08

(52) U.S. Cl. 380/279

(57) ABSTRACT

Encryption keys in a communication system are updated according to rekey groups having a common set of encryption keys or CKRs. Each group includes a number of radios with active and inactive keysets. A database records the relationships between rekey groups and keys, and the status of their keysets. An operator first determines one or more keys to be updated. New keys are then transmitted to each radio in one or more rekey groups using respective rekey messages. The new keys are stored in the inactive keysets of the radios. The inactive keysets are then activated using respective changeover messages. Deployment of new keys is carried out by software in the form of automated update tasks.

### RELATED APPLICATIONS

This application is a NONPROVISIONAL of, claims priority to and incorporates by reference U.S. Provisional Patent Application 61/251372, filed 14 Oct. 2009.

### BACKGROUND

This invention relates to methods of managing encryption keys in a radio communication system, and particularly to a method of updating the keys held by groups of radios in a communication system.

Radio communication systems often involve encrypted transmissions between user terminals, and between other devices in the system. A range of encryption keys is therefore usually provided and updated when required, by a key management facility (KMF). Groups of users within a system also often require special security, such as the members of a tactical group in the police force, for example.

A Common Key Reference (CKR) is an identifier that refers to a secure encryption key and associated data, each typically including a name or key ID, algorithm ID, key variable, and a key type such as traffic encryption key (TEK) or key encryption key (KEK). The secure key data referenced by a CKR held in a terminal may be updated by a direct connection to a key fill device (KFD), or by over the air rekeying (OTAR), which is preferable in a fleet which involves hundreds or thousands of terminals.

A talk group is a user defined group of terminals which are able to communicate in a common call using a shared encryption key. The call may involve voice or data traffic. A rekey group is defined as a group of terminals which have the same set of CKRs. A terminal may further contain active and inactive keysets, with the inactive keyset being updated while the active keyset is in use, and then switched to become the active keyset at an appropriate changeover point.

### SUMMARY OF THE INVENTION

The present invention provides methods for updating encryption keys in a radio communication system.

In one aspect the invention may be said to reside in a method for updating encryption keys in a radio communication system, including: defining one or more rekey groups containing radios having one or more shared encryption keys, determining one or more existing keys to be updated with new keys, transmitting the new keys to each radio in one or more rekey groups, using respective rekey messages, storing the new keys in inactive keysets of respective radios, and activating the inactive keysets in the rekey groups to become active keysets, using respective changeover messages. The steps of sending rekey messages and changeover messages are carried out automatically for each group, once initiated by an operator.

In a further aspect the invention also resides in a key management facility for a radio communication system, having terminals arranged in groups with active and inactive keysets for encrypted communications within the groups, including: an operator interface, a communication unit which sends and receives messages to and from the communication system, a database which stores encryption data relating to the groups, a cryptographic module which calculates new encryption keys for the groups when required by the operator, and a scheduling subsystem which transmits rekey messages to the groups containing new keys for respective inactive keysets, followed by changeover messages which cause the terminals to switch between active and inactive keys.

Preferably the scheduling subsystem sends the rekey messages and changeover messages automatically for all groups in the system, once initiated by an operator.

In another aspect the invention resides in a method of updating encryption keys in a radio communication system which has a plurality of radios assigned to rekey groups, including: creating a first update task relating to one or more of the rekey groups, creating a second update task relating to the same or different rekey group, each task involving deployment of one or more new keys to the respective groups, initiating the first and second update tasks, and executing the update tasks subject to conditions determined by any conflict between the two tasks. The conditions can include a delay of one task while awaiting completion of the other task or other interaction or constraint rules.

### BRIEF DESCRIPTION OF THE DRAWINGS

Embodiments of the invention will be described with respect to the accompanying drawings, of which:

FIG. 1 shows a key management facility carrying out key update tasks for groups of radios,

FIG. 2 shows typical components of the key management facility,

FIG. 3 shows a sequence of messages between the KMF and the groups of radios,

FIG. 4 shows the structure of a typical key update message from the KMF,

FIGS. 5, 6, 7 give examples of active and inactive keysets,

FIG. 8 outlines a key update task carried out by the KMF,

FIGS. 9, 10, 11 outline sub processes of the task in FIG. 8,

FIG. 12 indicates typical relationships between groups and key update tasks,

FIG. 13 gives an example of database information relating to groups and update tasks,

FIGS. 14, 15, 16 indicate typical user interfaces for key updates carried out by the KMF, and

FIG. 17 shows resolution of a conflict between two tasks.

### DETAILED DESCRIPTION

Referring to the drawings it will be appreciated that the invention can be implemented in a range of different forms for a variety of different communication systems. Conventional features of these systems will be known to a skilled reader and need not be described in detail. The embodiments described here are given by way of example only.

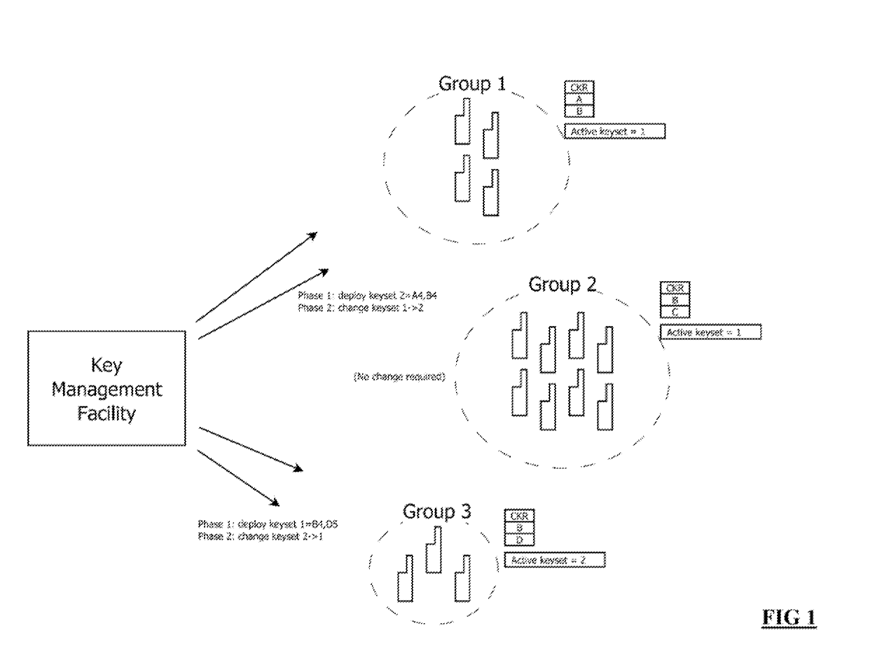

FIG. 1 schematically shows a communication system having a Key Management Facility and three rekey groups with active and inactive keysets. In this example, the terminals in rekey Group 1 require CKRs A, B in order to communicate in two different talk groups. Rekey Group 2 requires CKRs B, C. Rekey Group 3 requires CKRs B, D. The terminals in each group also have an active keyset containing the respective CKRs, being keyset 1 in Groups 1 and 2, and keyset 2 in Group 3.

The KMF in FIG. 1 undertakes a two phase process to update the keysets in two of the three groups, while the remaining group does not require any new keys. In phase 1 the KMF sends a rekey message containing key versions A4, B4 for the inactive keyset 2 of Group 1, and a separate rekey message containing keys B4, D5 for the inactive keyset 1 of Group 3. No messages are required for Group 2 so network traffic is reduced and the messaging process is relatively efficient in large systems. In phase 2, the KMF sends separate changeover messages to groups 1 and 3, causing the terminals in each group to switch between the active and inactive keysets. These messages can be multicast or unicast to the members of a group.

The update process in a key management facility such as indicated in FIG. 1 can be largely automated, as outlined below, to reduce difficulties which might arise if these steps were carried out separately for each group by a human operator. This reduces the likelihood that communications in the system will be disrupted by operator error. A key update task may be defined to determine the new keys that are to be applied to each group in a single update. A series of tasks is carried out by the KMF when rekeying one or more groups in the system.

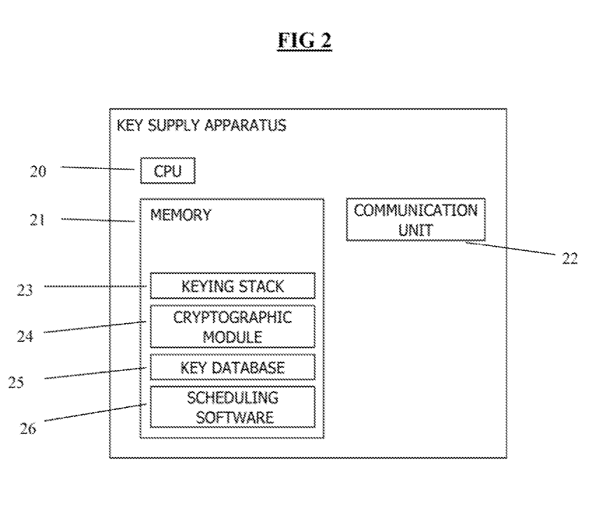

FIG. 2 indicates the components of a typical key supply apparatus which might be used in the KMF of FIG. 1. The facility is usually provided as a computer separate from the console of a dispatch radio system, from which a human operator provides a range of functions for the radio users. In this example, the computer includes a CPU 20, memory 21 and a communication unit 22 as conventional hardware. In relation to encryption keys and updates for the system, the memory contains a database 23 which stores encryption information relating to the rekey groups in the system, including the current contents of the active and inactive keysets, a cryptographic module 24 which calculates new keys for the groups, a keying stack 25 containing tasks ready to be executed for various groups, and scheduling software 26 which determines when rekey and changeover messages should be sent to the groups, and monitors replies.

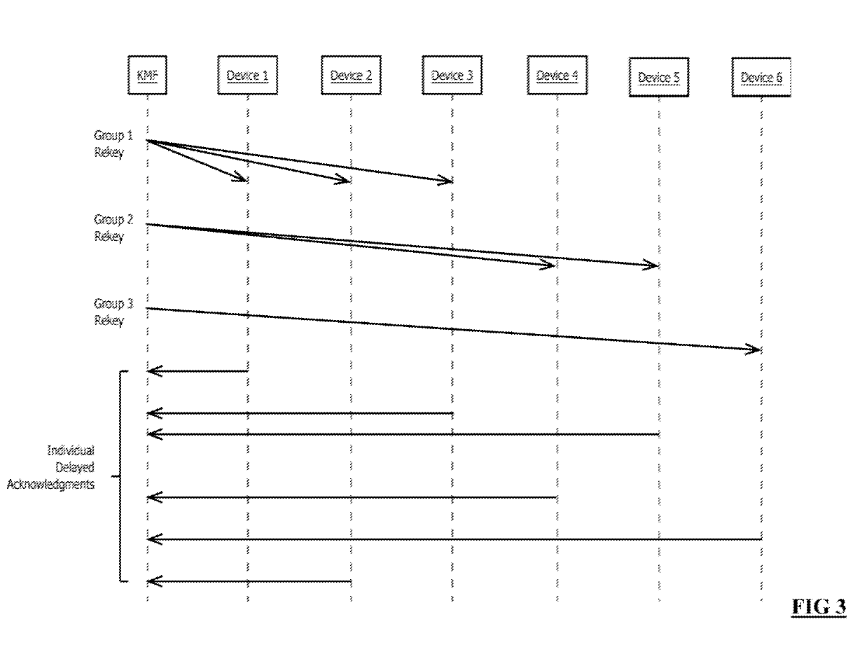

FIG. 3 outlines the flow of messages which may be sent and received by the communication unit in the KMF, during an update process as shown in FIG. 1 (The number of terminal devices do not match FIG. 1, and the messages relating to rekeying in phase 1 of the process only have been shown for clarity). The KMF sends a respective multicast message to each of Groups 1, 2, and 3, although individual messages could also be sent. Individual acknowledgements are transmitted by the devices in each group, using random delay intervals to avoid collisions. A similar process takes place for messages relating to the changeover in phase 2.

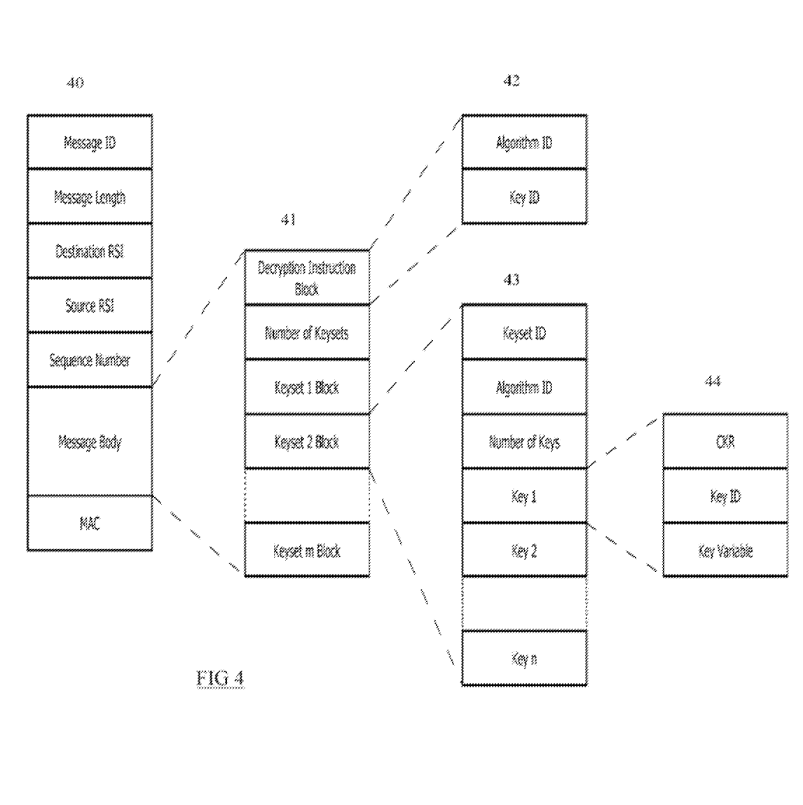

FIG. 4 shows a typical structure for a rekey message 40. The Message ID identifies the message as a rekey message, as opposed to a changeover message or delete key message. The Source and Destination RSI fields identify the sender and intended recipient of the message. Each message sent is assigned an increasing Sequence Number to identify the message. The recipient device references the sequence number in their response. The Message Authentication Code (MAC) block prevents replay attacks. For a rekey message, the Message Body 41 consists of a Decryption Instruction Block 42 and a number of Keyset blocks 43. The Decryption Instruction Block identifies the Key Encryption Key used to encrypt the key variables of any keys being transferred in the message. Each Keyset Block identifies the algorithm such as DES or AES of the keys contained within, and a list of keys 44.

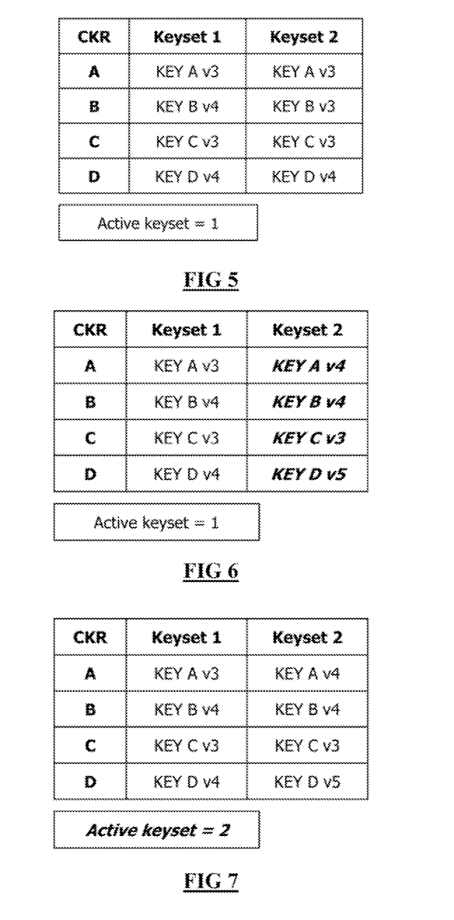

FIGS. 5. 6 and 7 indicate the result of the two phases of a group update process such as shown in FIG. 1. These figures respectively show the state of the CKRs stored in a radio terminal before, between and after phases 1 and 2 have been carried out. The terminal contains four CKRs, labelled A, B, C, D each having a version of a respective key in two keysets, which are active or inactive with respect to current communications.

In FIG. 5, keyset 1 is active, and key versions from this set are therefore used when required in talk group communications. In FIG. 6, the KMF has sent a rekey message to the group, containing new versions v4 and v5 for keys A and D, and these have been substituted in the inactive keyset 2. In FIG. 7, the KMF has now sent a changeover message to the group, so that keyset 2, containing the new versions of keys A. D is now active, rather than keyset 1.

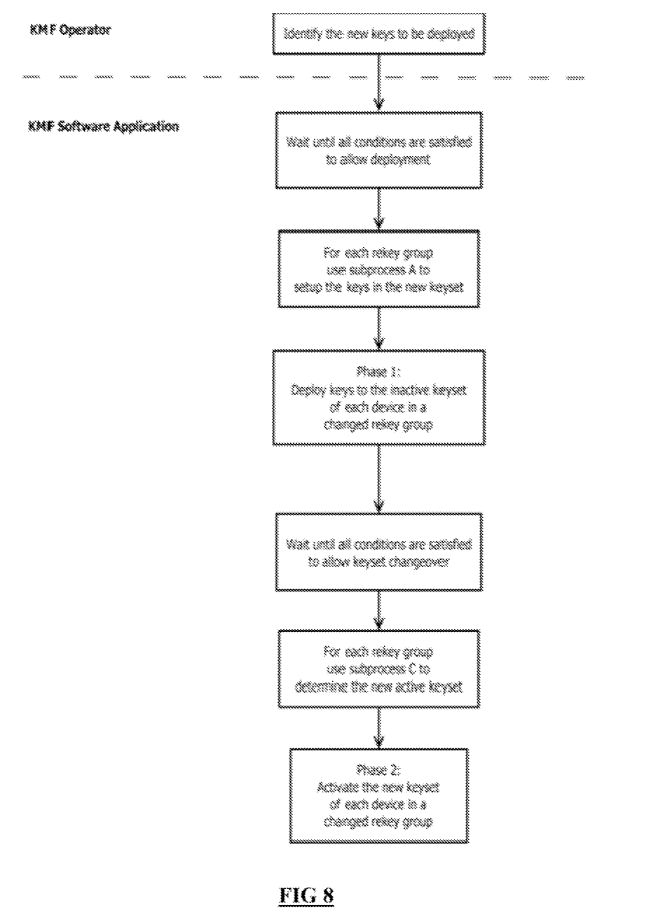

FIG. 8 indicates how update tasks are created by an operator and how the update processes in phase 1 and phase 2 in each task are carried out automatically by a KMF such as shown in FIG. 2. An operator initiates an update by determining that new keys must be deployed for one or more of the CKRs, because some of the keys may have been compromised for example, or because a regular change is required, and then activating the cryptographic module to create new keys. The operator creates one or more key update tasks in the KMF consisting of updates to CKRs and identifies any external conditions which must be applied. The scheduling software in the KMF then executes the key update tasks, at the appropriate time, which sends rekey messages containing the new keys to the appropriate groups, followed by the changeover messages which cause the respective terminals to switch keysets, without necessarily requiring further action by the operator. Execution of each task usually involves a number of sub-processes A, B, C and these may be subject to conditions such as the status of sub-processes in the execution of other tasks. For example, a task relating to one group may be blocked or delayed in order to resolve a potential conflict with another task relating to a different group.

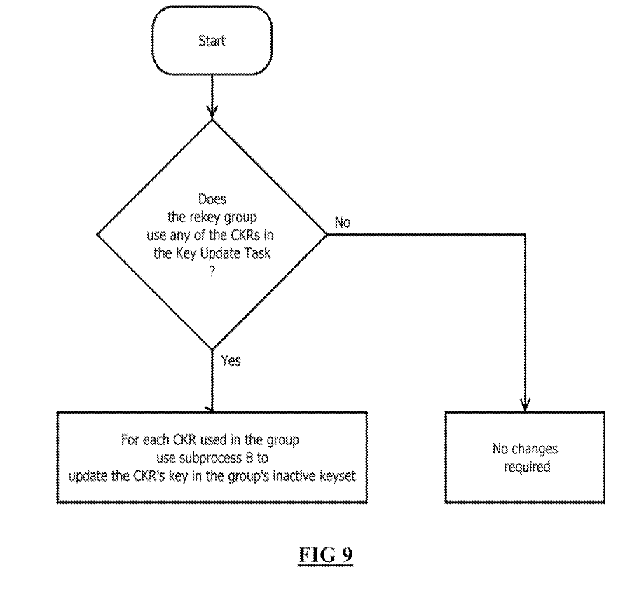

FIGS. 9, 10, 11 show sub-processes A, B, C implemented by a key update task to perform a deployment and changeover, when separately managing keysets for groups of devices, typically radio terminals, in a communication system. An operator has regenerated a number of CKRs and an update task has been created.

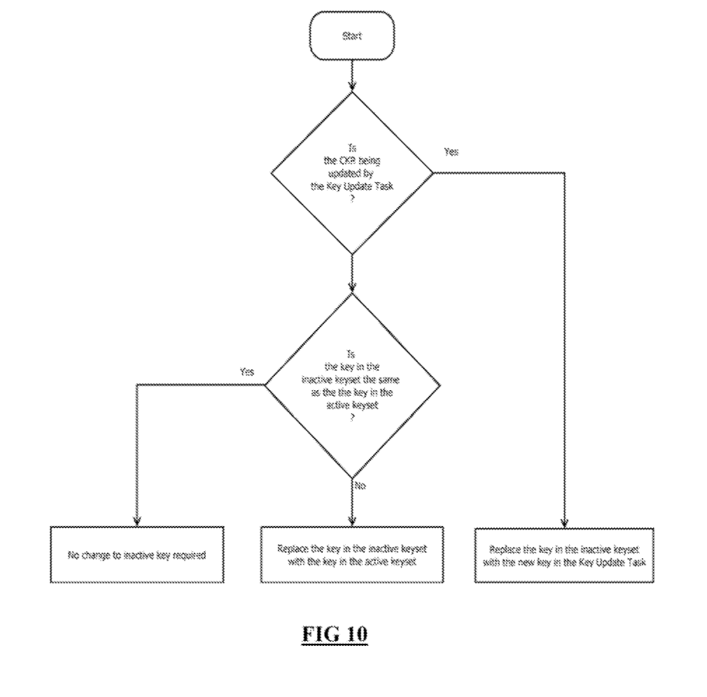

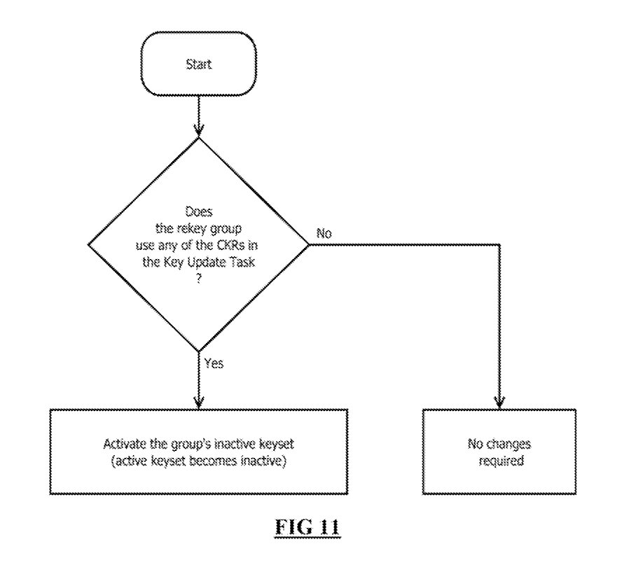

In FIG. 9, sub process A of the task now automatically considers each group in the database in turn to determine whether the group must be rekeyed. If a group does not use any of the CKRs which have been regenerated, then no changes are required for that group. Otherwise the inactive keyset for that group must be updated, in whole or in part, such as outlined in FIG. 10. Once every group has been considered, a series of rekey messages can be created and sent to the groups.

In FIG. 10, sub-process B of the task considers each CKR for the group to determine how the inactive keyset for the group must be updated. If a particular CKR is being updated, then the corresponding key in the inactive keyset must be replaced, ready for changeover to the active keyset. If the CKR is not being updated then the key may still need to be changed, to produce a correct result at changeover, such as for CKR B in FIG. 6. If the key in the inactive keyset does not match the corresponding key in the active keyset then the key in the inactive keyset is replaced with the key from the active keyset. Otherwise no change is required for the particular CKR.

In FIG. 11, sub-process C of the task again considers each group in the database in turn, to determine whether a changeover message is now required. If a group does not use any of the CKRs which have been regenerated, then no changeover is required for that group. Otherwise a changeover message or messages are created and sent by the communication unit.

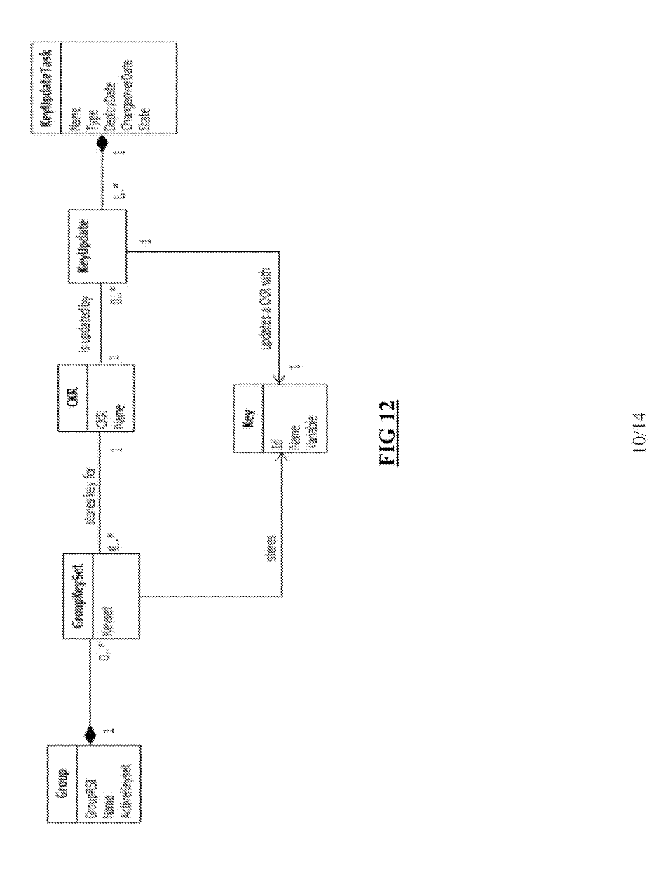

FIG. 12 is a generalised representation or schema showing how a database may be implemented to relate the groups with keysets and key update tasks. A Group has a number of GroupKeysets (typically 2), each one storing a Key for a CKR. A Key Update task consists of one to many key updates, each one identifying the key that updates a CKR. Looking at the relationships from the CKR table, it is seen that a CKR is updated by zero or many KeyUpdateTasks and that it may belong to zero or many Groups.

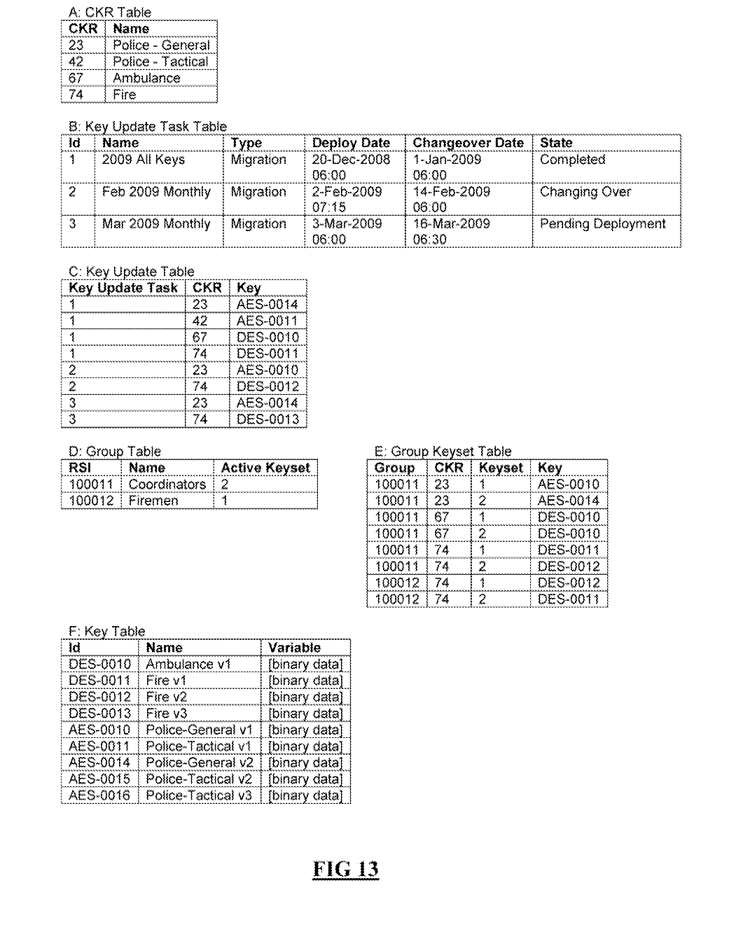

FIG. 13 illustrates a portion of the data which might be typical for a communication system operated by public services, namely police, ambulance and fire departments. Data relating to groups and keysets can be stored in database tables using the schema in FIG. 12. The data in this example is arranged in tables which list: A:CKRs for the communication system, B:Key Update Tasks currently on the KMF, C:the relation between Tasks and CKRs. D:Groups and E:Group Keysets, and F:Keys.

The last two rows of the GroupKeySet table E in FIG. 13 show that the group identified by 10012 (Firemen) specifies that radios in this group only require keys for CKR 74 (named Fire). They should have the key identified by DES-0012 (named Fire v2) in their keyset 1 and DES-0011 (named Fire v1) in their keyset 2. Furthermore, the Group table specifies that Firemen radios are currently required to have keyset 1 active. Communications among Firemen are therefore encrypted with the key in keyset 1 (DES-0012). Similarly, the group identified by 100011 (Coordinators) require keys for CKRS 23, 67, 74 (named Police-General, Ambulance, Fire). Radios in this group should have the keys identified by AES-0010, DES-0010, DES-0011 in keyset 1, which is inactive, and keys AES-0014, DES-0010, DES-0012 in keyset 2, which is active. Communications involving Coordinators are therefore encrypted with one of the keys in keyset 2 depending on the group to which the communications relate.

The Task table B in FIG. 13 indicates three update tasks in different stages of completion during February 2009. Task 1 was a yearly update of all keys and was completed at the beginning of January. Tasks 2 and 3 represent a monthly update of keys 23 and 74 being carried out in February and March, and throughout the year. Task 2 has recently sent rekey messages to deploy keys AES-0010 (Police-General v1) and DES-0012 (Fire v2) for CKRs 23 and 74 respectively. Both CKRs have been sent to the inactive keyset 1 of the Coordinator group. CKR 74 has been sent to the inactive keyset 2 of the Firemen group. Changeover messages for activation of these inactive keysets, and corresponding deactivation of the currently active keysets, are being sent to each radio in these groups but the changeover has not yet taken place. Task 3 will soon be due to send rekey messages to deploy further keys AES-0014 (Police-General v2) and DES-0013 (Fire v3) for CKRs 23 and 74.

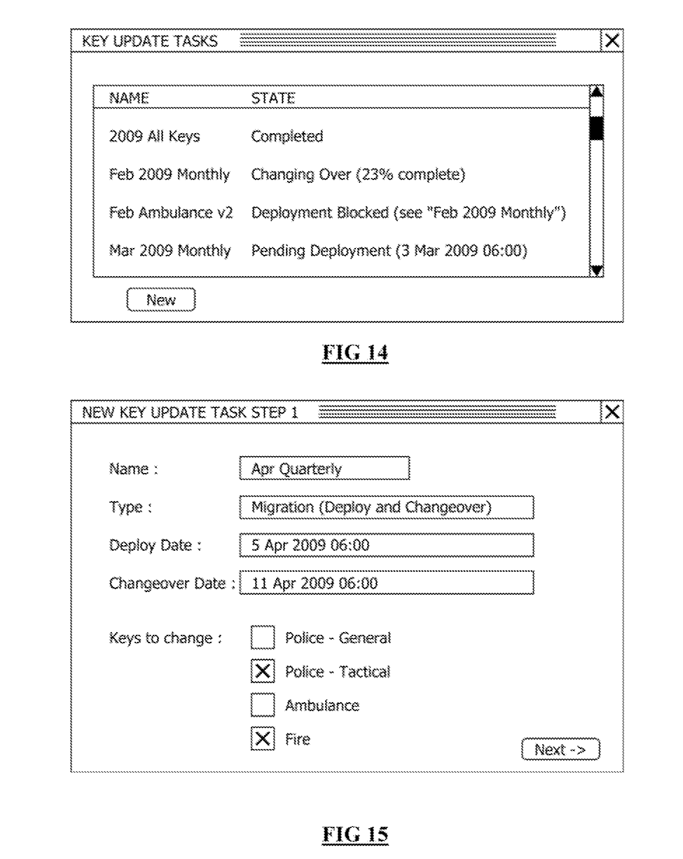

FIGS. 14, 15, 16 show how control of the KMF might be presented to an operator, for the first part of the process shown in FIG. 8. In FIG. 14 the content of the Key Update Task table is displayed, indicating the status of monthly tasks. In this example, the Feb ambulance v2 tasks has been blocked while Feb 2009 monthly is still underway. The operator can create a new task from this screen, by selecting “New”.

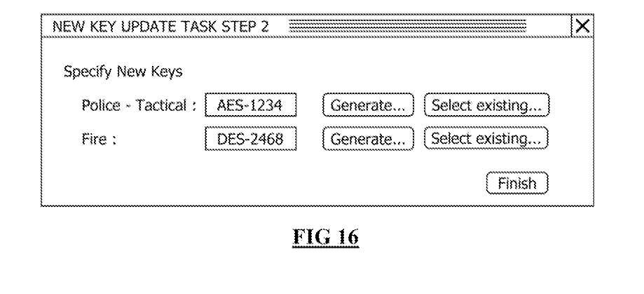

FIG. 15 shows the first step of how a new task can be created. In this example the operator has determined that keys for the Police Tactical group and the Fire group will be changed at particular dates and times during April 2009. Selecting “Next” completes this step. FIG. 16 shows the second step of how new keys may be specified for these groups. Selecting “Finish” completes the step and commences the automated processes described in relation to FIGS. 9, 10, 11.

A range of benefits may be possible using one or more key update tasks in a communication system. The tasks can be automatically scheduled to cause deployment and changeover at predetermined times.

Different update strategies can be assigned to a task such as: deploy only the new keys to both keysets simultaneously, with no changeover required (This is efficient if a compromised key is to be removed quickly from the system); deploy only the new keys to the inactive keyset, then at changeover swap the affected keys across keysets by deploying the new keys to the active keyset and simultaneously deploying the replaced keys to the inactive keyset (This is more efficient if a small number of keys are affected); provide rules controlling when tasks can be implemented to prevent problems of interference (This prevents possible loss of communication when tasks are executed concurrently and may adversely affect each other).

The KMF can implement automatic checking to prevent deployment and changeover phases from executing unless certain criteria are met. Typically this may be done to prevent loss of communications caused by a conflict between simultaneously running tasks, or a task running before the system currency has stabilised.

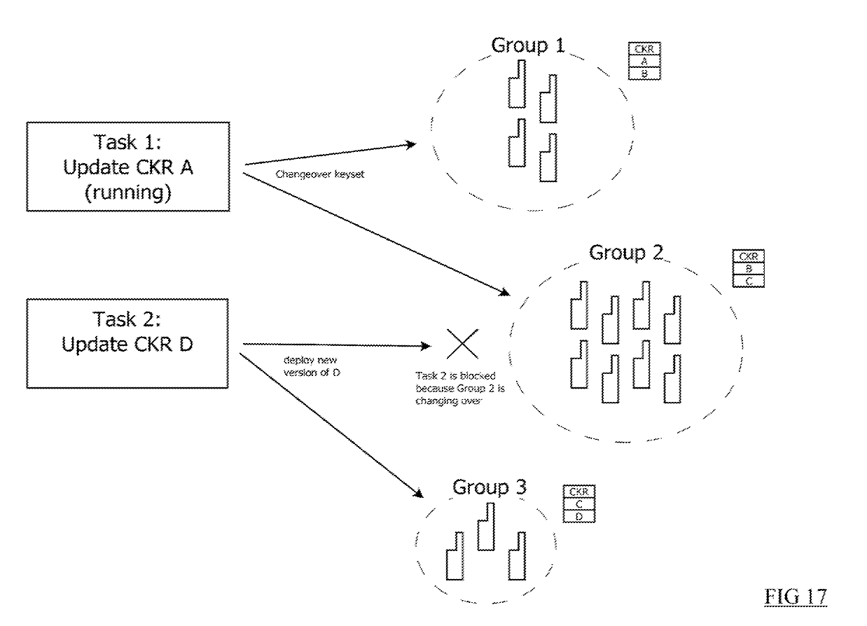

FIG. 17 illustrates how two tasks may affect each other, even when the updating keys appear unrelated. Task 1 is instructing Groups 1 and 2 to changeover after previously deploying a new key for CKR A to the inactive keyset of each device. if Task 2 were to run at this time, some devices may lose communication for a time during these processes. To understand how this can occur, consider what might happen if Task 2 was allowed to run concurrently with Task 1. If a device in Group 2 received the new key for CKR D and then received the changeover from Task 1, the device would start using the new key D before the rest of the group 2. The rest of group 2 would be unable to decrypt communications from that device.

What is claimed is:

1. A method for updating encryption keys in a radio communication system, including:
defining one or more rekey groups containing radios having one or more shared encryption keys,
determining one or more existing keys to be updated with new keys,
transmitting the new keys to each radio in one or more rekey groups, using respective rekey messages,
storing the new keys in inactive keysets of respective radios, and
activating the inactive keysets in the rekey groups to become active keysets, using respective changeover messages.

2. The method of claim 1 wherein the steps of sending rekey messages and changeover messages are carried out automatically for each group once initiated by an operator.

3. A key management facility for a radio communication system having terminals arranged in groups with active and inactive keysets for encrypted communications within the groups, including:
an operator interface,
a communication unit which sends and receives messages to and from the communication system,
a database which stores encryption data relating to the groups,
a cryptographic module which calculates new encryption keys for the groups when required by the operator, and
a scheduling subsystem which transmits rekey messages containing new keys to the groups for respective inactive keysets, and transmits changeover messages which cause the terminals to switch between active and inactive keys.

4. The method of claim 3 wherein the scheduling subsystem sends the rekey messages and changeover messages to the respective groups automatically once initiated by an operator.

5. A method of updating encryption keys in a radio communication system having a plurality of radios assigned to rekey groups, including:
creating a first update task relating to one or more of the rekey groups,
creating a second update task relating to the same or a different rekey group, each task involving deployment of one or more new keys to the respective groups,
initiating the first and second update tasks, and
executing the update tasks subject to conditions determined by any conflict between the two tasks.

6. The method of claim 5 wherein the conditions include a delay of one task while awaiting progress of the other task.
